(19) United States
(12) Patent Application Publication
(10) Pub. No.: US 2015/0207966 A1
(43) Pub. Date: Jul. 23, 2015

(54) IMAGE PICKUP DEVICE UNIT INCLUDING IMAGE PICKUP DEVICE AND DEVICE HOLDING FRAME, AND OPTICAL DEVICE

(71) Applicant: CANON KABUSHIKI KAISHA, Tokyo (JP)

(72) Inventor: Tomoyuki Kudoh, Tokyo (JP)

(21) Appl. No.: 14/596,656

(22) Filed: Jan. 14, 2015

(30) Foreign Application Priority Data
Jan. 20, 2014 (JP) 2014-007856

(51) Int. Cl. H04N 5/225; G02B 7/02

(52) U.S. Cl. CPC H04N 5/2253; H04N 5/2254; G02B 7/028; H04N 2101/00

(57) ABSTRACT

An image pickup device unit that can accurately position and hold an image pickup device to realize reduction in a thickness of the image pickup device unit in an optical axis direction and that can efficiently dissipate heat generated by the image pickup device. A device substrate is electrically connected to and arranged on a back side of the image pickup device. A heat conductive device holding frame has an opening for inserting the image pickup device and a plurality of receiving pieces for receiving, from a front side of the image pickup device and in an optical axis direction, the image pickup device inserted to the opening from a back side of the device holding frame to position the image pickup device in the optical axis direction relative to the device holding frame.

### BACKGROUND OF THE INVENTION

1. Field of the Invention

The present invention relates to an optical device including an image pickup apparatus, such as a digital camera, provided with an image pickup device unit.

2. Description of the Related Art

In digital cameras and the like, pixels and sizes of image pickup devices are increasing along with the request of high image quality. An example of a structure for holding the image pickup device includes a technique of arranging a substrate on the back of the image pickup device and holding the front side of the substrate by a metal frame (Japanese Laid-Open Patent Publication (Kokai) No. 2004-187243). Also proposed is a technique of arranging a substrate on the back of the image pickup device and holding the image pickup device by a metal plate arranged on the back of the substrate (Japanese Laid-Open Patent Publication (Kokai) No. 2001-285722).

The metal frame for holding the image pickup device is arranged on the front side of the substrate in Japanese Laid-Open Patent Publication (Kokai) No. 2004-187243. However, there are problems that the positioning of the metal frame and the image pickup device in an optical axis direction is not taken into account, and a heat dissipation route of heat generated by the image pickup device to the metal frame is not reserved.

Since the metal plate is arranged on the back of the substrate in Japanese Laid-Open Patent Publication (Kokai) No. 2001-285722, there is a problem that a thickness in an optical axis direction of the image pickup device unit is increased, and the image pickup device unit is thereby enlarged.

### SUMMARY OF THE INVENTION

The present invention provides an image pickup device unit and an optical device that can accurately position and hold an image pickup device to realize reduction in a thickness of the image pickup device unit in an optical axis direction and that can efficiently dissipate heat generated by the image pickup device.

Accordingly, a first aspect of the present invention provides an image pickup device unit comprising an image pickup device, a device substrate configured to be arranged on a back side of the image pickup device and be electrically connected to the image pickup device, and a device holding frame with heat conductivity configured to be provided with an opening for inserting the image pickup device, wherein the device holding frame is provided with a plurality of receiving pieces for receiving, from a front side of the image pickup device and in an optical axis direction, the image pickup device inserted to the opening from a back side of the device holding frame to position the image pickup device in the optical axis direction relative to the device holding frame, and the image pickup device is fixed to and held by the device holding frame in the positioned state.

Accordingly, a second aspect of the present invention provides an optical device comprising an image pickup device unit including an image pickup device, a device substrate arranged on a back side of the image pickup device and electrically connected to the image pickup device, and a device holding frame with heat conductivity provided with an opening for inserting the image pickup device, wherein the device holding frame is provided with a plurality of receiving pieces for receiving, from a front side of the image pickup device and in an optical axis direction, the image pickup device inserted to the opening from a back side of the device holding frame to position the image pickup device in the optical axis direction relative to the device holding frame, and the image pickup device is fixed to and held by the device holding frame in the positioned state.

According to the present invention, the device holding frame with heat conductivity provided with the opening for inserting the image pickup device is included, and the device holding frame is provided with the plurality of receiving pieces for receiving, from the front side of the image pickup device and in the optical axis direction, the image pickup device inserted to the opening from the back side of the device holding frame to position the image pickup device in the optical axis direction relative to the device holding frame. As a result, the image pickup device is fixed to and held by the device holding frame in the positioned state. Therefore, the image pickup device can be accurately positioned and held to realize the reduction in the thickness of the image pickup device unit in the optical axis direction, and the heat generated by the image pickup device can be efficiently dissipated.

Further features of the present invention will become apparent from the following description of exemplary embodiments (with reference to the attached drawings).

### BRIEF DESCRIPTION OF THE DRAWINGS

FIG. 1A is a perspective view from a front side of a digital camera that is an example of an embodiment of an optical device of the present invention, and FIG. 1B is a view from a back side of the digital camera shown in FIG. 1A.

FIG. 2 is a control block diagram of the digital camera shown in FIGS. 1A and 1B.

FIG. 3 is a sectional view along an optical axis direction of a lens barrel in a housing state.

FIG. 4 is a sectional view along the optical axis direction of the lens barrel in a shooting state (extended state).

FIG. 5 is a perspective view of a movable cam ring, an outer cylinder, and a fixed cam ring.

FIG. 6 is an exploded perspective view of the lens barrel.

FIG. 7A is a view from a front side of an image pickup device unit, FIG. 7B is a top view of FIG. 7A, and FIG. 7C is a right side view of FIG. 7A.

FIG. 8 is an exploded perspective view from an object side of the image pickup device unit including a device unit holding frame.

FIG. 9 is an exploded perspective view from a back side of the image pickup device unit of FIG. 8.

FIGS. 10A to 10C are schematic views for comparing the present invention and conventional examples.

### DESCRIPTION OF THE EMBODIMENTS

An example of an embodiment of the present invention will now be described with reference to the drawings.

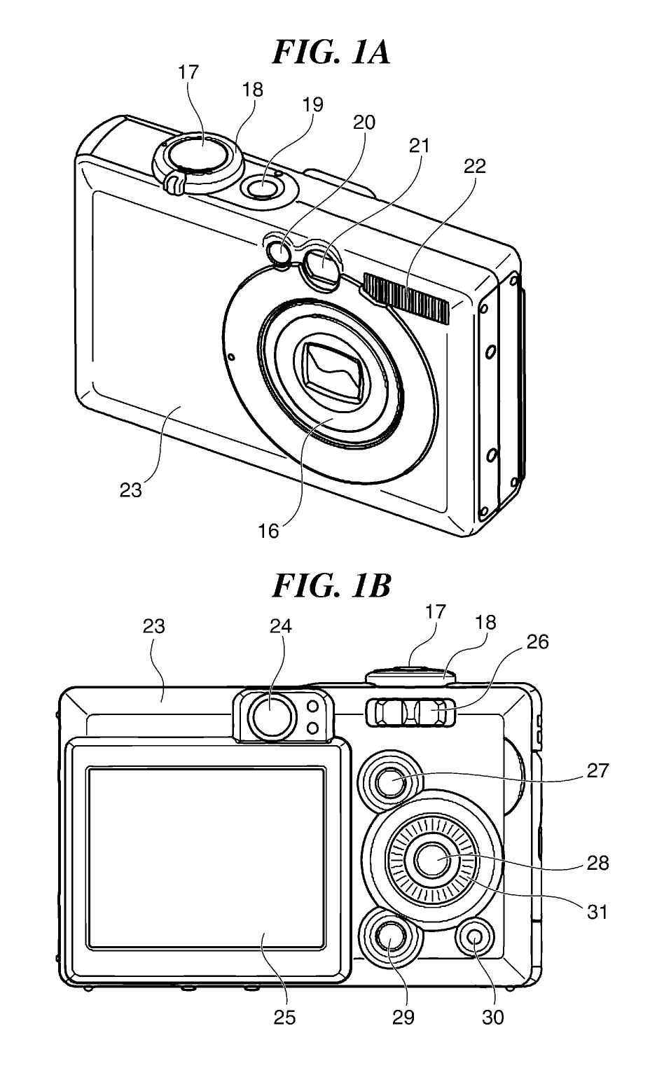

FIG. 1A is a perspective view from a front side of a digital camera that is an example of an embodiment of an optical device of the present invention, and FIG. 1B is a view from a back side of the digital camera shown in FIG. 1A.

As shown in FIG. 1A, a digital camera 23 of the present embodiment includes, on the front side, a finder 21 that determines a composition of an object, an auxiliary light source 20 for photometry and range-finding, a stroboscopic device 22, and a lens barrel 16. The lens barrel 16 is a zoom-type lens barrel that moves in an optical axis direction between a shooting position and a housing position to change the image pickup magnification.

The digital camera 23 includes, on an upper side, a release button 17, a power switching button 19, and a zoom switch 18. As shown in FIG. 1B, the digital camera 23 includes, on a back side, operation buttons 26 to 31, a display 25 such as an LCD, and a finder eyepieces 24.

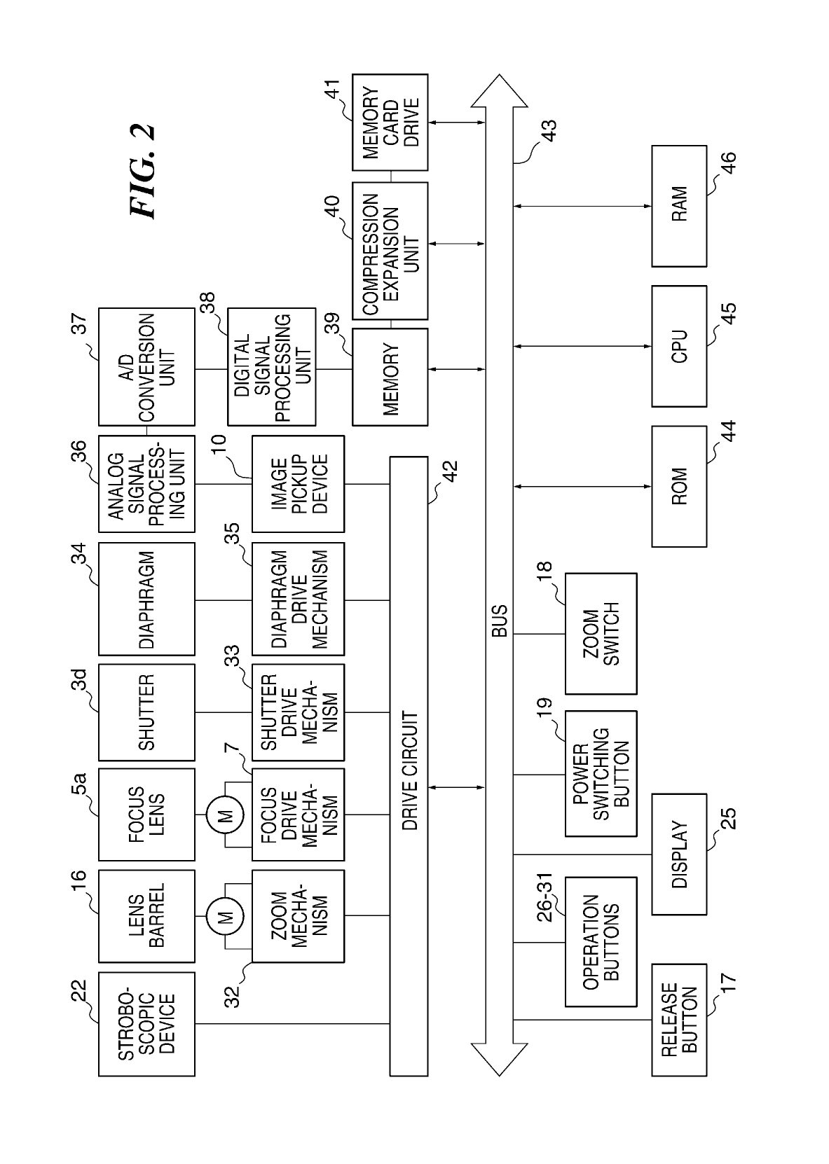

FIG. 2 is a control block diagram of the digital camera 23 shown in FIGS. 1A and 1B. A CPU 45, a ROM 44, a RAM 46, the release button 17, the operation buttons 26 to 31, the display 25, the power switching button 19, the zoom switch 18, a memory 39, a compression expansion unit 40, a memory card drive 41, and a drive circuit 42 are connected to a bus 43.

A zoom mechanism 32 that drives the zoom of the lens barrel 16, a focus drive mechanism 7 that drives the focus lens 5a, a shutter drive mechanism 33 that drives a shutter 3d, and a diaphragm drive mechanism 35 that drives a diaphragm 34 are connected to the drive circuit 42. An image pickup device 10, such as a CCD sensor and a CMOS sensor, and the stroboscopic device 22 are also connected to the drive circuit 42. The drive of the units connected to the drive circuit 42 is controlled through the drive circuit 42 based on signals from the CPU 45.

Various control programs and the like are stored in the ROM 44, and data necessary for the various control programs are stored in the RAM 46. An analog signal processing unit 36 applies analog processing to image data output from the image pickup device 10 and outputs the image data to an A/D conversion unit 37.

The A/D conversion unit 37 converts analog data imported from the image pickup device 10 into digital data and outputs the digital data to a digital signal processing unit 38. The digital signal processing unit 38 applies a predetermined process to the digital data converted by the A/D conversion unit 37 and outputs image data to the memory 39.

The compression expansion unit 40 applies a compression process, such as JPEG and TIFF, to the image data stored in the memory 39, and the image data is output and stored in a memory card mounted on the memory card drive 41.

The compression expansion unit 40 can apply an expansion process to the image data stored in the memory 39 or the image data stored in the memory card drive 41 to display the image data on the display 25 through the bus 43.

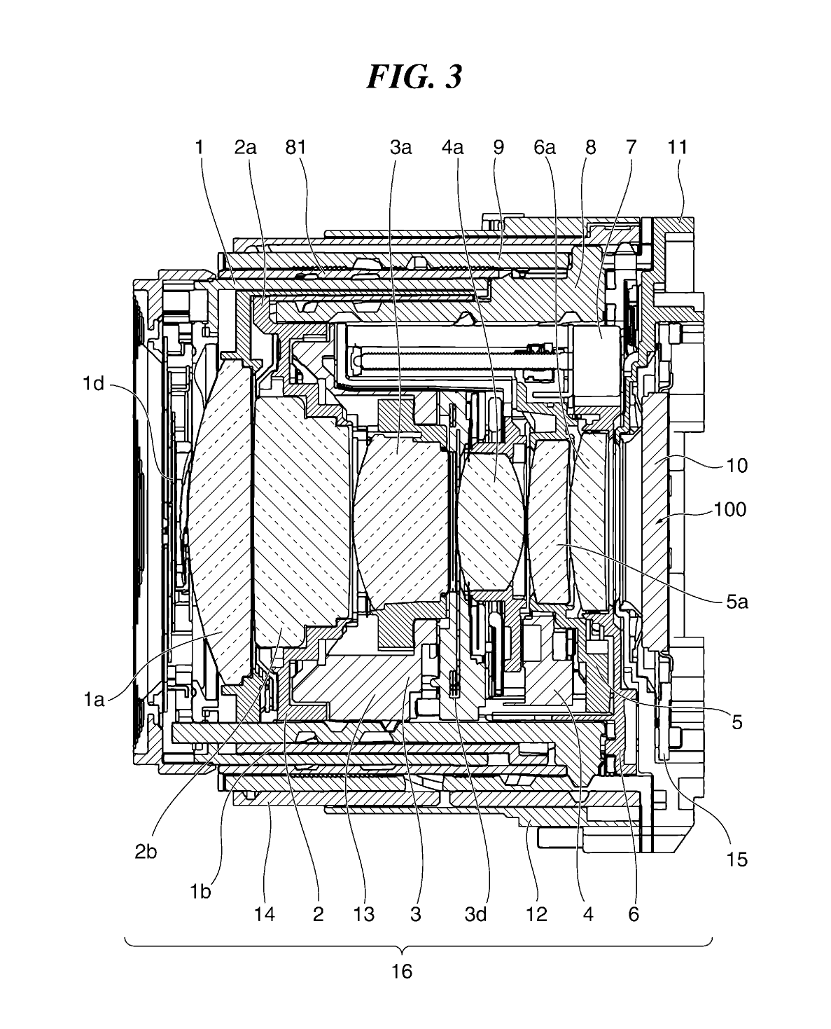

The lens barrel 16 will be described with reference to FIGS. 3 to 6.

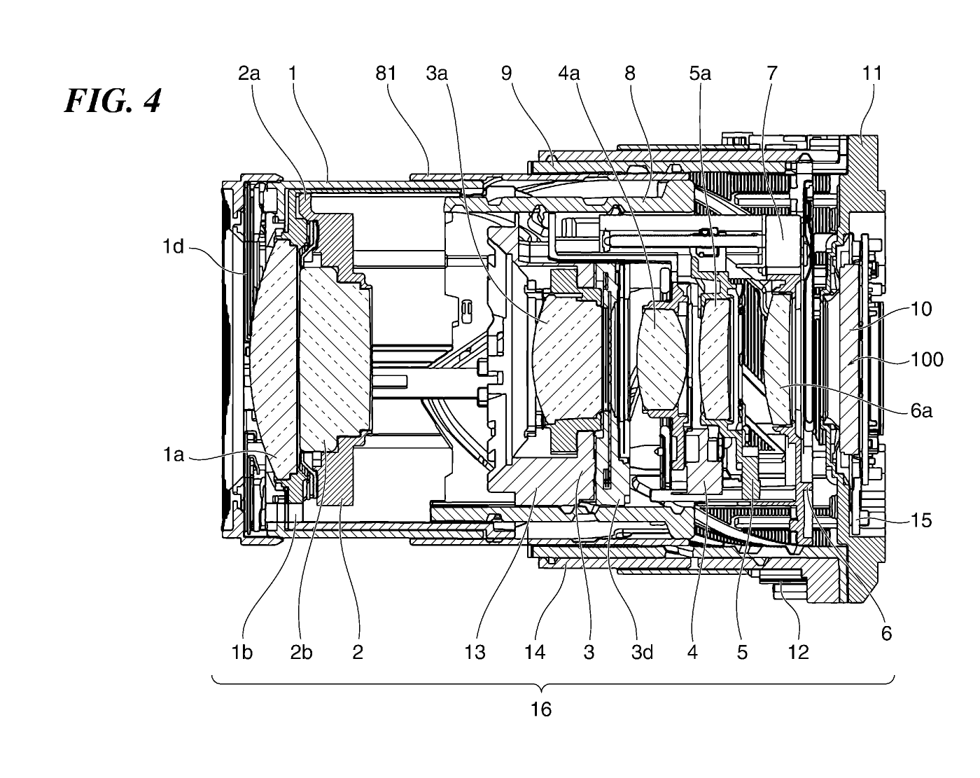

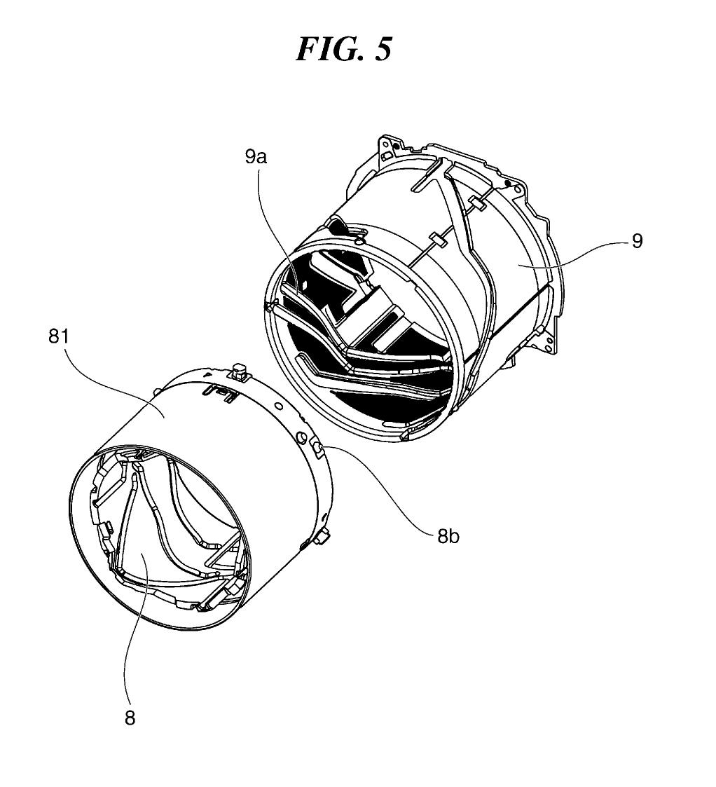

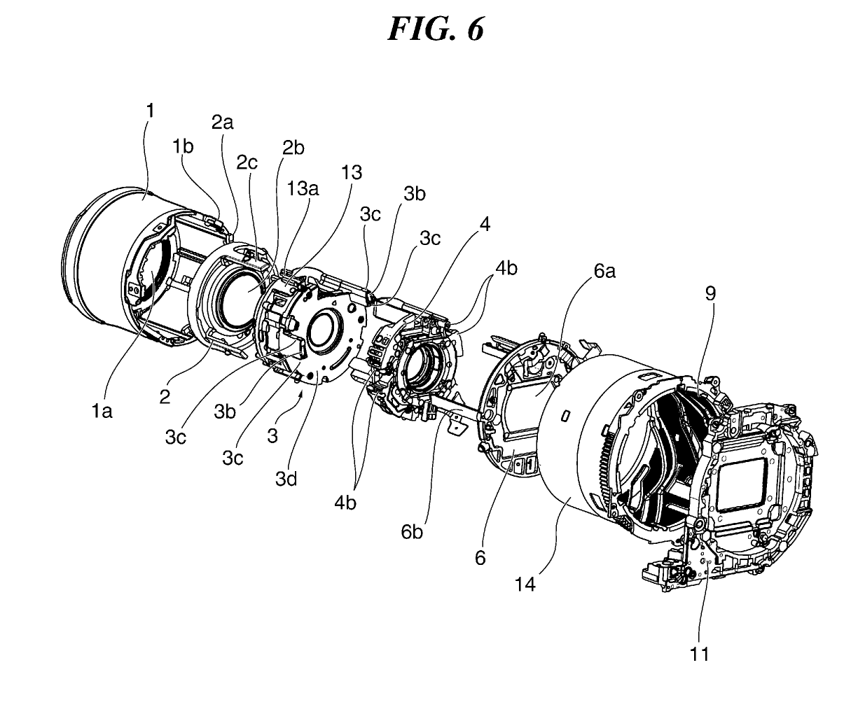

FIG. 3 is a sectional view along the optical axis direction of the lens barrel 16 in a housing state. FIG. 4 is a sectional view along the optical axis direction of the lens barrel 16 in a shooting state (extended state). FIG. 5 is a perspective view of a movable cam ring 8, an outer cylinder 81, and a fixed cam ring 9. FIG. 6 is an exploded perspective view of the lens barrel 16.

As shown in FIGS. 3 to 6, the lens barrel 16 includes a first group lens holding section 1b that holds a first group lens 1a. A barrier holding section 1 is arranged on the front side of the first group lens holding section 1b. A second group lens holding section 2 that holds a second group lens 2b is arranged on the back side of the first group lens holding section 1b. A third group lens holding section 3 is arranged on the back side of the second group lens holding section 2. The third group lens holding section 3 includes a third group lens holding frame 13 that holds the third group lens 3a, and the shutter 3d arranged on the back side of the third group lens holding frame 13.

A fourth group lens holding section 4 that holds a fourth group lens 4a functioning as a vibration-proof lens is provided on the back side of the third group lens holding section 3, and a focus lens holding section 5 that holds a focus lens 5a is provided on the back side of the fourth group lens holding section 4.

A sixth group lens holding section 6 for holding a sixth group lens 6a is provided on the back side of the focus lens holding section 5, and the focus lens holding section 5 and the sixth group lens holding section 6 form a focus unit.

A focus motor 7 is fixed to the sixth group lens holding section 6, and the drive of the focus motor 7 moves the focus lens holding section 5 in the optical axis direction to perform focusing operation. A device unit holding frame 11 that holds an image pickup device unit 100 including the image pickup device 10, such as a CCD or CMOS sensor, is provided on the back side of the sixth group lens holding section 6.

The movable cam ring 8 is provided on the outer peripheral side of the second group lens holding section 2, the third group lens holding section 3, and the fourth group lens holding section 4. Cam grooves corresponding to the second group lens holding section 2, the third group lens holding section 3, and the fourth group lens holding section 4 are formed on inner peripheral sections of the movable cam ring 8.

The second group lens holding section 2, the third group lens holding section 3, and the fourth group lens holding section 4 can move in the optical axis direction by following the corresponding cam grooves formed on the inner peripheral sections of the movable cam ring 8. The first group lens holding section 1b is provided on the outer peripheral side of the movable cam ring 8, and the first group lens holding section 1b can move in the optical axis direction by following a cam groove formed on an outer peripheral section of the movable cam ring 8.

The barrier holding section 1 is arranged on the outer peripheral side of the first group lens holding section 1b. The barrier holding section 1 can move in the optical axis direction with a cam locus different from that of the first group lens holding section 1b by following a cam groove different from the cam groove followed by the first group lens holding section 1b formed on the outer peripheral section of the movable cam ring 8.

The fixed cam ring 9 is provided on the outer peripheral side of the movable cam ring 8. The movable cam ring 8 can move in the optical axis direction by following a cam groove formed on an inner peripheral section of the fixed cam ring 9. A drive ring 14 is provided on the outer peripheral side of the fixed cam ring 9, and a cover cylinder 12 covers and protects the outer peripheral side of the drive ring 14.

The sixth group lens holding section 6 follows a cam groove formed on an inner peripheral section of the drive ring 14, while the rotation is restricted by the fixed cam ring 9. The zoom mechanism 32 rotates the drive ring 14 on the outer peripheral side of the fixed cam ring 9, and the sixth group lens holding section 6 moves back and forth in the optical axis direction along the cam groove of the drive ring 14.

The movable cam ring 8 also rotates on the inner peripheral side of the fixed cam ring 9 along with the rotation of the drive ring 14. A follower 8b (see FIG. 5) of the movable cam ring 8 follows a cam groove 9a of the fixed cam ring 9, and the movable cam ring 8 rotates to move back and forth in the optical axis direction. The barrier holding section 1, the first group lens holding section 1b, the second group lens holding section 2, the third group lens holding section 3, the fourth group lens holding section 4, and the sixth group lens holding section 6 move in the optical axis direction along with the rotation of the movable cam ring 8.

As shown in FIG. 6, rotation restriction sections 6b extending toward the object side parallel to the optical axis are integrated with the outer peripheral section of the sixth group lens holding section 6, and rotation restricted sections 3b are integrated with the shutter 3d of the third group lens holding section 3.

The rotation restricted sections 3b are formed in a sheath shape. The rotation restriction sections 6b are inserted when the sixth group lens holding section 6 moves back and forth in the optical axis direction, and the rotation restricted sections 3b hold the inserted rotation restriction sections 6b. Two pairs of the rotation restriction section 6b and the rotation restricted section 3b are arranged at substantially 180° apart in a circumferential direction of the lens barrel 16.

Rotation restriction abutted sections 3c are provided on both sides in the circumferential direction of the lens barrel 16 of the rotation restricted sections 3b. Rotation restriction abutting sections 4b provided on the fourth group lens holding section 4 are abutted to the rotation restriction abutted sections 3c in the circumferential direction. In this way, the third group lens holding section 3 restricts the rotation of the fourth group lens holding section 4.

A plurality of rotation restriction sections 2c extending toward an image surface side parallel to the optical axis are provided on the outer peripheral section of the second group lens holding section 2 in the circumferential direction. The rotation restriction sections 2c are inserted to straight grooves 13a provided on the outer peripheral section of the third group lens holding frame 13 in the optical axis direction when the second group lens holding section 2 and the third group lens holding section 3 move relative to each other in the optical axis direction. In this way, the third group lens holding section 3 restricts the rotation of the second group lens holding section 2.

A plurality of rotation restriction projections 2a protruding outside in a radial direction is provided on the outer peripheral section of the second group lens holding section 2 in the circumferential direction. The rotation restriction projections 2a are inserted to straight grooves provided on the inner peripheral section of the first group lens holding section 1b when the second group lens holding section 2 and the first group lens holding section 1b move relative to each other in the optical axis direction. In this way, the second group lens holding section 2 restricts the rotation of the first group lens holding section 1b.

The outer cylinder 81 is provided on the outer peripheral side of the movable cam ring 8, at a position on the outer peripheral side of the barrier holding section 1. The outer cylinder 81 and the movable cam ring 8 are mutually fixed by snap-fits at three parts, and the outer cylinder 81 and the movable cam ring 8 move back and forth together in the optical axis direction.

Next, the assembly of the lens barrel 16 will be described in the order of assembly. First, the second group lens holding section 2, the third group lens holding section 3, and the fourth group lens holding section 4 are incorporated into the inner peripheral section of the movable cam ring 8. The movable cam ring 8 is then incorporated from the image surface side of the fixed cam ring 9. In this case, the follower 8b of the movable cam ring 8 is incorporated into the cam groove 9a of the fixed cam ring 9.

The focus unit including the sixth group lens holding section 6, the drive ring 14, and the cover cylinder 12 are incorporated, and the device unit holding frame 11 holding the image pickup device unit 100 is assembled to cover the back side. In this state, eccentricity adjustment, such as correction of tilt or eccentricity of the lenses of the second group lens holding section 2, the third group lens holding section 3, the fourth group lens holding section 4, and the sixth group lens holding section 6, can be performed to adjust the optical axis. In this way, a lens barrel 16 with excellent optical sensitivity can be provided.

Subsequently, the movable cam ring 8 is rotated in an extending direction up to an assembly phase on an extending side, and in this state, the first group lens holding section 1b and the barrier holding section 1 are assembled on the outer peripheral side of the movable cam ring 8. The movable cam ring 8 is rotated once in the housing direction to move the movable cam ring 8 to a mechanical end on the extending side, and in this state, the outer cylinder 81 is incorporated into the outer peripheral side of the first group lens holding section 1b and the movable cam ring 8.

The barrier holding section 1 holds a barrier blade 1d that can be opened and closed. The barrier blade 1d is opened at the shooting position of the lens barrel 16 shown in FIG. 4, and the barrier blade 1d is closed at the shooting position of the lens barrel 16 shown in FIG. 3 to protect the first group lens 1a.

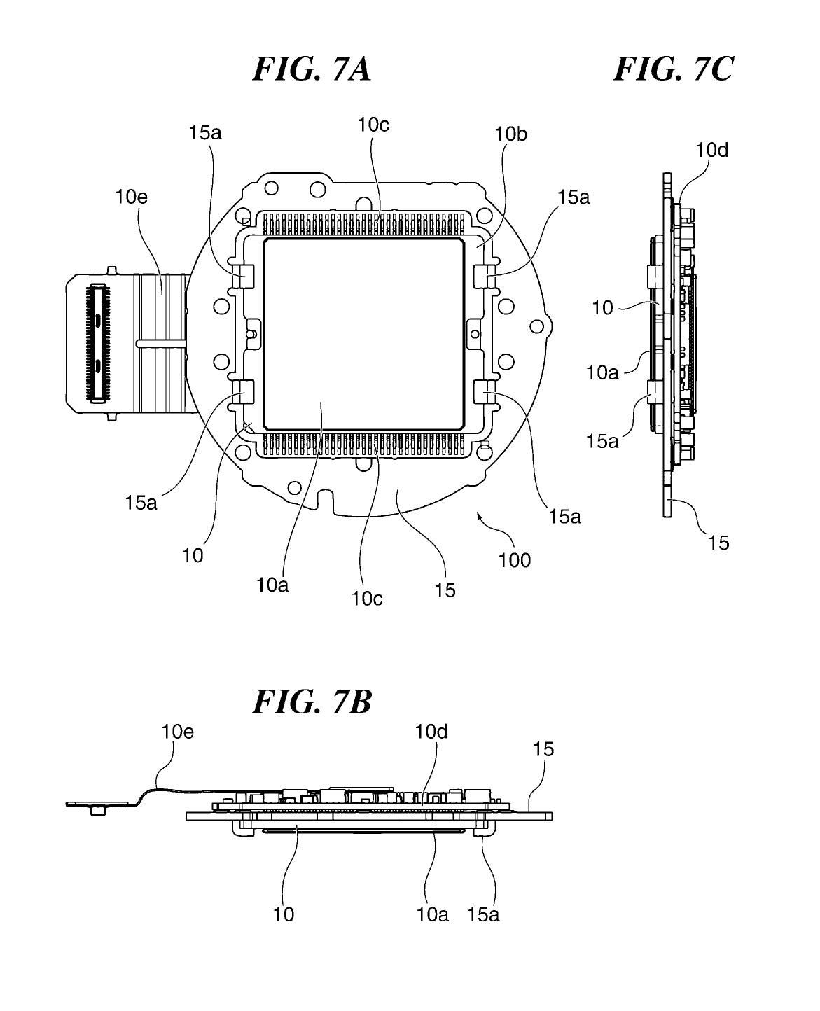

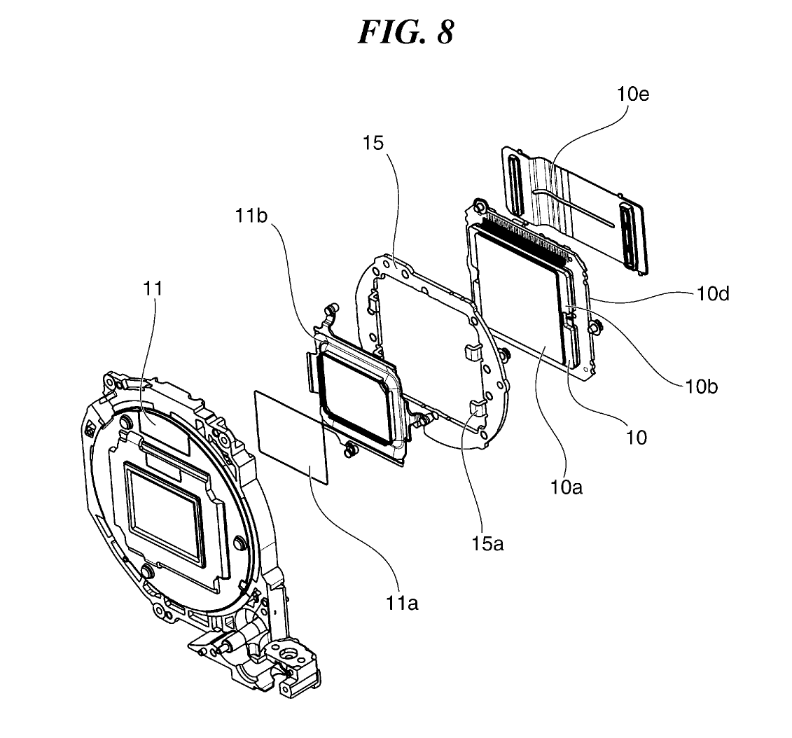

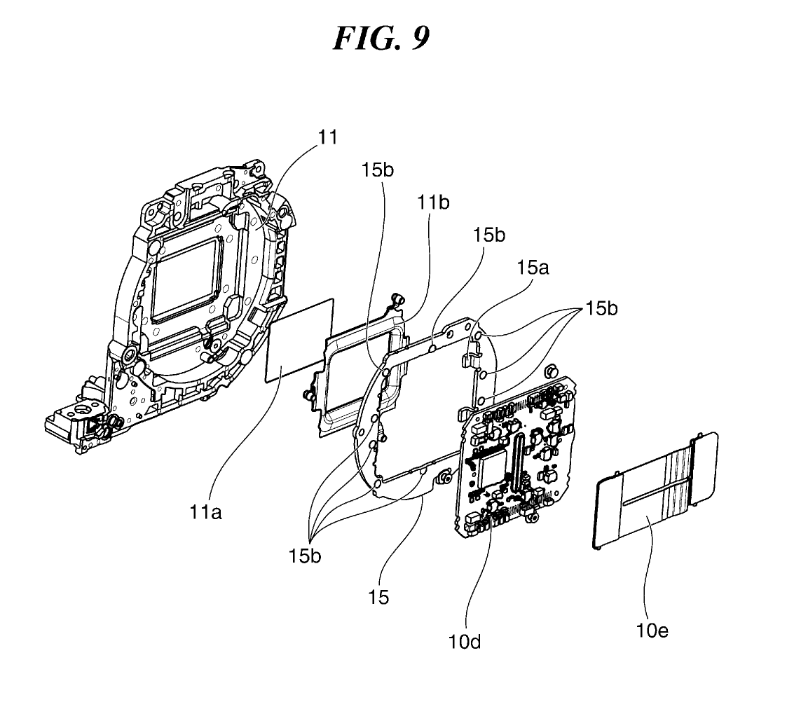

The image pickup device unit 100 held by the device unit holding frame 11 will be described with reference to FIGS. 7A to 10C. FIG. 7A is a view from the front side of the image pickup device unit 100, FIG. 7B is a top view of FIG. 7A, and FIG. 7C is a right side view of FIG. 7A. FIG. 8 is an exploded perspective view from the object side of the image pickup device unit 100 including the device unit holding frame 11. FIG. 9 is an exploded perspective view from the back side of FIG. 8.

As shown in FIGS. 7A to 7C, the image pickup device unit 100 includes a plurality of uniformly arranged connection terminals 10c on mutually opposed upper and lower sides of the image pickup device 10. The image pickup device 10 is electrically connected to a device substrate 10d arranged on the back side, through the connection terminals 10c. A heat-conductive device holding frame 15 made of metal or the like holds the image pickup device 10 electrically connected to the device substrate 10d.

A rectangular opening for inserting the image pickup device 10 from the back side is formed at a center of the device holding frame 15. A device cover 10a smaller than the image pickup device 10 is provided on the front side of the image pickup device 10.

A substantially L-shaped receiving pieces 15a for receiving, in the optical axis direction, left and right side sections of the image pickup device 10 inserted to the opening from the back side of the device holding frame 15 are provided on left and right sides of the opening on the front side of the device holding frame 15. The receiving pieces 15a are arranged at four locations in total, two locations on each of the left and right sides of the opening on the front side of the device holding frame 15. The receiving pieces 15a receive, in the optical axis direction, sections 10b on the left and right sides where the device cover 10a of the image pickup device 10 is not arranged.

In this way, the image pickup device 10 is mechanically positioned relative to the device holding frame 15 in the optical axis direction, and stable position accuracy can be ensured. In this case, the device cover 10a and the receiving pieces 15a are substantially on the same plane, and the image pickup device 10 can be held without increasing the total thickness in the optical axis direction.

After the image pickup device 10 is positioned relative to the device holding frame 15 in the optical axis direction, the image pickup device 10 is fixed to the device holding frame 15 by adhesion or the like. Although the parts to be adhered may be the upper and lower connection terminals 10c of the image pickup device 10, the sides provided with the receiving pieces 15a on the left and right sides are suitable. It is most effective for upper and lower sides of the two receiving pieces 15a and between the two receiving pieces 15a to adhere to each other. Only two sides on the left and right of the image pickup device 10 are adhered and fixed, and connection terminals 10c are not adhered. Therefore, the condition of connection of the image pickup device 10 and the device substrate 10d can be checked and repaired afterward.

A large number of electric devices as well as connectors are arranged on the back of the device substrate 10d, and an image pickup flexible portion 10e needs to be connected to the connectors. When the image pickup flexible portion 10e is connected after the image pickup device 10 is fixed to the device holding frame 15 by adhesion or the like, a load may be applied to the device substrate 10d from the back, and the connection section of the connection terminals 10c and the device substrate 10d may be damaged.

Therefore, a plurality of convex sections 15b is provided on the back side of the device holding frame 15 in the present embodiment. When a load is applied from the back side of the device substrate 10d, receiving pieces 15a receive the image pickup device 10, and the plurality of convex sections 15b receives the device substrate 10d. This can prevent the device holding frame 15 from holding the front sides of the image pickup device 10 and the device substrate 10d at the same time to put a large load on the connection terminals 10c and can protect the connection section of the connection terminals 10c and the device substrate 10d.

The image pickup device unit 100 assembled in this way is incorporated into the device unit holding frame 11. The device unit holding frame 11 has an opening at a center thereof, and an optical glass 11a is incorporated into the device unit holding frame 11 from the back side. A dust-proof rubber 11b is incorporated from the back side of the optical glass 11a, and the image pickup device unit 100 is incorporated from the back side of the dust-proof rubber 11b. In this incorporation state, the dust-proof rubber 11b is held to seal between the optical glass 11a and the image pickup device 10 of the image pickup device unit 100, and attachment of dust from the outside on the surface of the image pickup device 10 is prevented.

The image pickup device 10 generates much heat during operation, and the heat needs to be dissipated to prevent a loss of function. In the present embodiment, the device holding frame 15 directly holds the front side of the image pickup device 10, and the heat generated by the image pickup device 10 is directly transmitted from the receiving pieces 15a to the device holding frame 15 and dissipated. In the present embodiment, the outside diameter of the device holding frame 15 is increased to increase the heat dissipation effect.

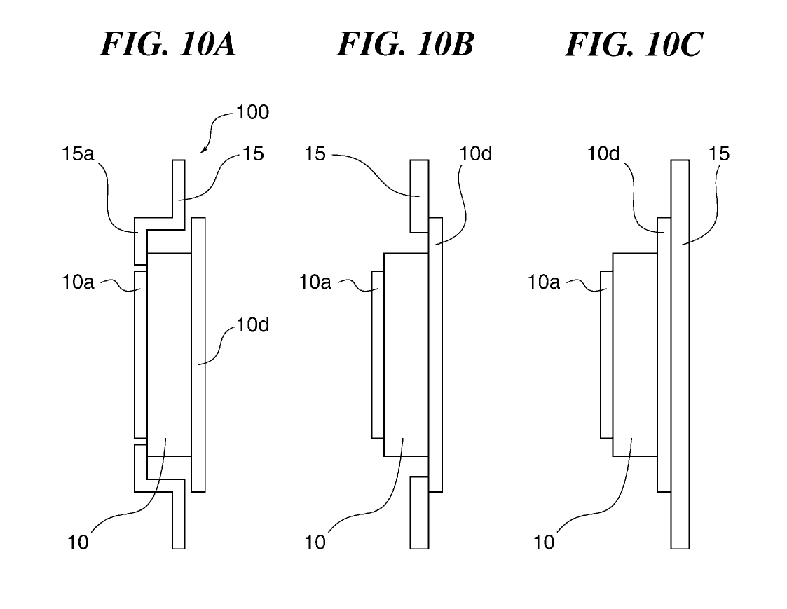

FIGS. 10A to 10C are schematic views for comparing the present invention and conventional examples. FIG. 10A shows the image pickup device unit 100 of the present embodiment, and the receiving pieces 15a of the device holding frame 15 hold the front side of the image pickup device 10.

Meanwhile, FIGS. 10B and 10C show image pickup device units in conventional examples. In FIG. 10B, the device holding frame 15 is not positioned relative to the image pickup device 10 in the optical axis direction and is not in contact with the image pickup device 10. Therefore, it is difficult to ensure the positional accuracy of the image pickup device 10 in the optical axis direction, and the heat dissipation effect cannot be expected. In FIG. 10C, the device holding frame 15 is arranged on the back of the image pickup device 10, and the thickness of the image pickup device unit in the optical axis direction is large.

As described, the image pickup device 10 is accurately positioned and held in the present embodiment to realize the reduction in the thickness of the image pickup device unit 100 in the optical axis direction. Therefore, the camera can be downsized, and the heat generated by the image pickup device 10 can be efficiently dissipated.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-007856, filed Jan. 20, 2014, which is hereby incorporated by reference wherein in its entirety.

What is claimed is:

1. An image pickup device unit comprising:
an image pickup device;
a device substrate configured to be arranged on a back side of said image pickup device and be electrically connected to said image pickup device; and
a device holding frame with heat conductivity configured to be provided with an opening for inserting said image pickup device,
wherein said device holding frame is provided with a plurality of receiving pieces for receiving, from a front side of said image pickup device and in an optical axis direction, said image pickup device inserted to the opening from a back side of said device holding frame to position said image pickup device in the optical axis direction relative to said device holding frame, and
said image pickup device is fixed to and held by said device holding frame in the positioned state.

2. The image pickup device unit according to claim 1, wherein a device cover is provided at a center on the front side of said image pickup device, and the receiving pieces receive a section not provided with the device cover of said image pickup device in the optical axis direction.

3. An image pickup device unit according to claim 2, wherein the receiving pieces and the device cover are arranged on substantially a same plane in the optical axis direction.

4. The image pickup device unit according to claim 1, wherein a connection terminal for connection to said device substrate is provided on each of mutually opposed sides of said image pickup device, and the receiving pieces are arranged on mutually opposed sides of said image pickup device not provided with the connection terminals.

5. The image pickup device unit according to claim 4, wherein said image pickup device is fixed by adhesion to said device holding frame, on the sides provided with the receiving pieces.

6. The image pickup device unit according to claim 1, wherein a plurality of convex sections for receiving a load added from a back side of said device substrate is provided on a back of the device holding frame.

7. An optical device comprising:
an image pickup device unit including an image pickup device, a device substrate arranged on a back side of the image pickup device and electrically connected to the image pickup device, and a device holding frame with heat conductivity provided with an opening for inserting the image pickup device, wherein the device holding frame is provided with a plurality of receiving pieces for receiving, from a front side of the image pickup device and in an optical axis direction, the image pickup device inserted to the opening from a back side of the device holding frame to position the image pickup device in the optical axis direction relative to the device holding frame, and the image pickup device is fixed to and held by the device holding frame in the positioned state.
